(19) United States
(12) Patent Application Publication
(10) Pub. No.: US 2016/0307441 A1
(43) Pub. Date: Oct. 20, 2016

(54) SYSTEM FOR LANE SELECTION BY AN AUTOMATED VEHICLE

(71) Applicant: DELPHI TECHNOLOGIES, INC., Troy, MI (US)

(72) Inventors: JONATHAN L. WIESKAMP, SUNNYVALE, CA (US); MICHAEL H. LAUR, MISSION VIEJO, CA (US)

(21) Appl. No.: 14/685,958

(22) Filed: Apr. 14, 2015

(51) Int. Cl. G08G 1/01; G01C 21/26; H04N 5/232; B62D 15/02

(52) U.S. Cl. CPC G08G 1/01; B62D 15/0255; G01C 21/26; H04N 5/23229

(57) ABSTRACT

A system for automated operation of a vehicle includes a controller and a regulated-lane-detector. The controller is operable to determine a vehicle-status that indicates if the vehicle complies with regulations to legally travel in a regulated-lane of a roadway. The regulated-lane-detector is in communication with the controller and operable to determine when a regulated-lane is present on a roadway. The system selects a travel-lane for the vehicle to travel upon based on the vehicle-status.

### TECHNICAL FIELD OF INVENTION

This disclosure generally relates to a system for automated operation of a vehicle, and more particularly relates to a system that determines when the vehicle complies with regulations to legally travel in a regulated-lane of a roadway, and selects a travel-lane for the vehicle to travel upon based on the regulations.

### BACKGROUND OF INVENTION

Some highways have regulated lanes such as public-transportation only lanes, or high-occupancy vehicle (HOV) lanes, also known as carpool lanes. In order to legally travel in a regulated-lane, the vehicle must meet certain requirements. For example, the vehicle must transport a minimum number of occupants to legally occupy a particular lane, or have a special provision from government. Prior automated systems either assume access to all lanes of a roadway or require the driver to place the vehicle in the regulated-lane.

### SUMMARY OF THE INVENTION

The improved system for controlling the automated operation of an automated vehicle described herein determines if access to a regulated-lane is permissible and can be taken into consideration when path-planning. In an automated vehicle, determining the available lanes is essential for effective path planning. When a regulated-lane is available as a possible option for the path-planning, the system determines if the vehicle complies with the regulations to travel in the regulated-lane. For example, the system may determine if the number of occupants meets the criteria necessary to use an available HOV-lane. The number of occupants may be determined using sensors provided for a Passenger Occupant Detection System (PODS) of an airbag system.

In accordance with one embodiment, a system for automated operation of a vehicle is provided. The system includes a controller and a regulated-lane-detector. The controller is operable to determine a vehicle-status that indicates if the vehicle complies with regulations to legally travel in a regulated-lane of a roadway. The regulated-lane-detector is in communication with the controller and operable to determine when a regulated-lane is present on a roadway. The system selects a travel-lane for the vehicle to travel upon based on the vehicle-status.

Further features and advantages will appear more clearly on a reading of the following detailed description of the preferred embodiment, which is given by way of non-limiting example only and with reference to the accompanying drawings.

### BRIEF DESCRIPTION OF DRAWINGS

The present invention will now be described, by way of example with reference to the accompanying drawings, in which:

FIG. 1 is a top view of a multi-lane roadway traveled by an automated vehicle equipped with a system for lane selection in accordance with one embodiment; and

FIG. 2 is a diagram of the system of FIG. 1 in accordance with one embodiment.

### DETAILED DESCRIPTION

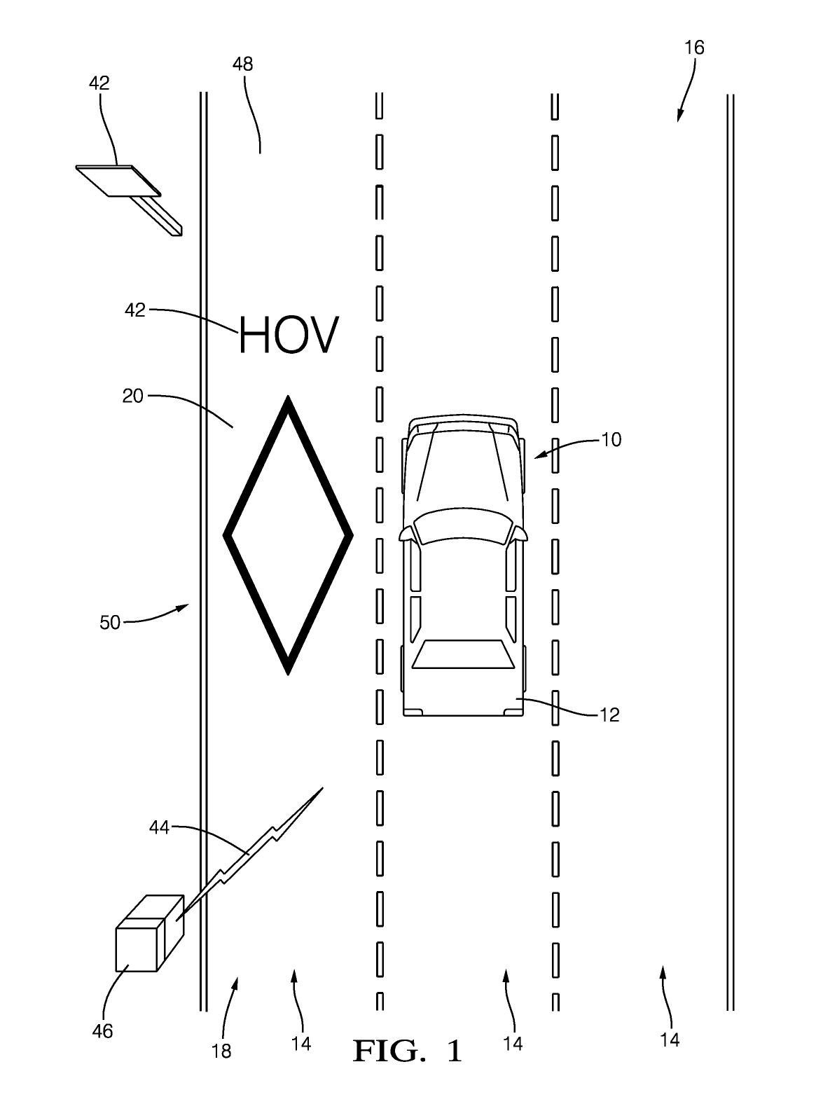

FIG. 1 illustrates a non-limiting example of a system 10 installed in a vehicle 12 for automated operation of the vehicle 12. Systems for fully automated operation of a vehicle have been proposed. The proposed systems control the speed, steering, brakes, and other aspects of vehicle operation necessary for the vehicle 12 to travel in a travel-lane 14 of a roadway 16 without interaction from an occupant (not shown) within the vehicle. While the improvements described herein are presented in the context of a fully automated vehicle, it is contemplated that the teachings presented herein could be applied to vehicles that are not automated or partially automated, as will become apparent as the system 10 is described in more detail below. As will also become apparent in the description that follows, an improvement provided by the system 10 described herein is that the system selects the travel-lane 14 (e.g. left lane, center lane, right lane) for the vehicle 12 to travel upon based on regulations that restrict legal usage of a particular lane to vehicles with a particular characteristic or status. That is, the system 10 determines if the vehicle 12 complies with regulations to legally travel in a regulated-lane 18, such as a high-occupancy-vehicle-lane 20, hereafter the HO V-lane 20.

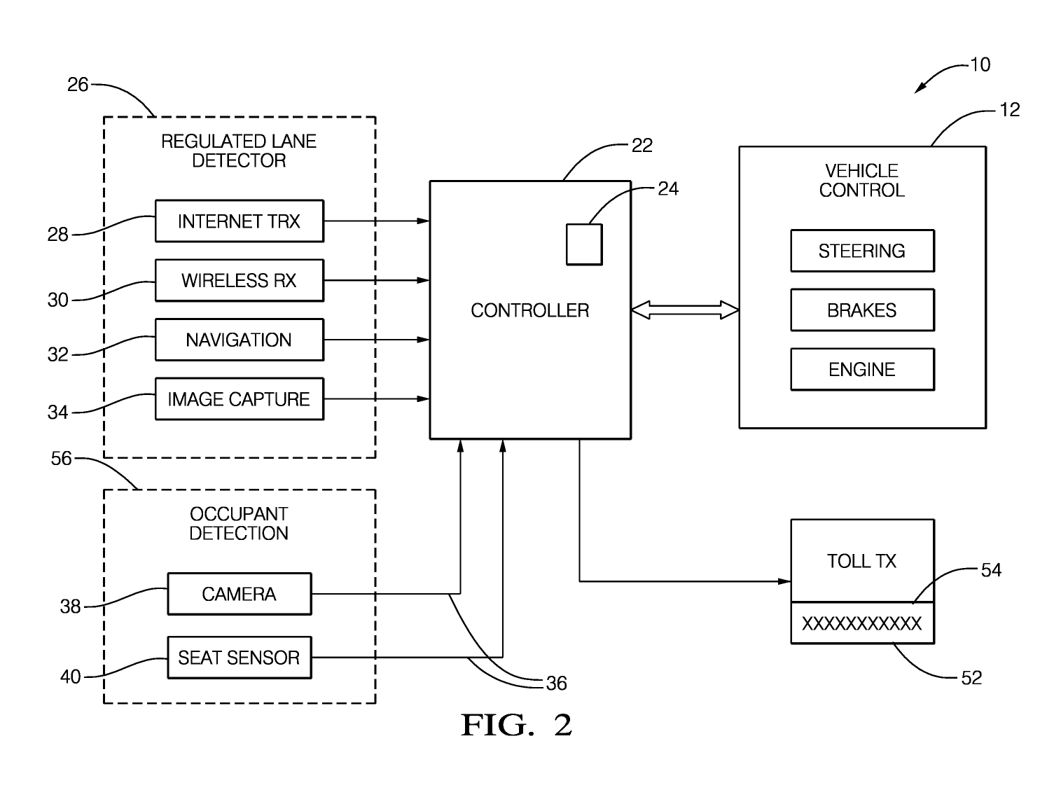

FIG. 2 further illustrates non-limiting details of the system 10. The system 10 includes a controller 22 that is operable to or configured to determine a vehicle-status 24 of the vehicle 12. In general, the vehicle-status 24 indicates if the vehicle 12 complies with regulations to legally travel in the regulated-lane 18 of the roadway 16. That is, the vehicle-status 24 corresponds to a characteristic of the vehicle such as, for example, the type of vehicle, a special government authorization, what the vehicle 12 is transporting, and other characteristics that will be described in more detail below. The vehicle-status 24 may be predetermined and stored in the controller 22 because the vehicle 12 always complies with regulations to legally travel in the regulated-lane 18, or the vehicle status 24 may be learned or determined each time the vehicle 12 is started, or continuously evaluated as the vehicle 12 travels.

The controller 22 may include a processor (not shown) such as a microprocessor or other control circuitry such as analog and/or digital control circuitry including an application specific integrated circuit (ASIC) for processing data as should be evident to those in the art. The controller 22 may include memory (not shown), including non-volatile memory, such as electrically erasable programmable read-only memory (EEPROM) for storing one or more routines, thresholds and captured data. The one or more routines may be executed by the processor to perform steps for determining if signals received by the controller 22 indicate that the vehicle 12 may travel upon, or avoid travel upon the regulated-lane 18 as described herein.

The system 10 also includes a regulated-lane-detector 26 in communication with the controller 22. The regulated-lane-detector 26 is operable to or configured to determine when regulated-lane 18 is present on a roadway 16 proximate to or nearby the vehicle 12. A number of ways that the regulated-lane-detector 26 are contemplated, which may use various devices such as, but not limited to an internet-transceiver 28 (INTERNET TRX), a wireless receiver 30 (WIRELESS RX), a navigation device 32 (NAVIGATION), and/or an image-capture device 34 (IMAGE CAPTURE). By equipping the system 10 with the controller 22 and the regulated-lane-detector 26 describe thus far, the system 10 is able to select a travel-lane 14 for the vehicle 12 to travel upon based on the vehicle-status 24. That is, when the vehicle 12 is operating in an automated mode, the system 10 may steer the vehicle 12 into the regulated-lane 18 if the vehicle-status 24 indicates that the vehicle 12 complies with regulations to legally travel in the regulated-lane 18, or avoid traveling in the regulated-lane 18 if the vehicle 12 does not comply with regulations to legally travel in the regulated-lane 18.

FIG. 2 shows various parts of the system 10 as being separate and distinct from the controller 22. However, this is only done to simplify the explanation of the system 10. It is recognized that some or all of the various parts could be integrated into a single unit, i.e. a super-controller. For example, the algorithms or logic for controlling steering direction (STEERING), brake actuation (BRAKES), and engine operation (ENGINE) that make up some of the vehicle control logic (VEHICLE CONTROL) may be distributed to various locations about the vehicle 12, or all contained in a single unit. So the controller 22 may be operable to steer the vehicle 12 during automated operation of the vehicle 12, or the controller 22 may be limited to only indicating to some other part of the system 10 that an adjacent lane (e.g. the HOV-lane 20) should or should not be traveled upon.

Further examples of the regulated-lane 18 include, but are not limited to, lanes for vehicles that use a particular source of energy such as compressed-natural-gas (CNG) or stored electricity; vehicles with special government authorization such as bus or other form of public transportation, or vehicles used by a law enforcement agency; vehicles operating in an automated manner, either fully automated or partially automated; or, as suggested above, vehicles that are occupied by a sufficient number of occupants to encourage carpooling.

By way of further example and not limitation, the regulated-lane-detector 26 may be operable to determine when the regulated-lane 18 is a high-occupancy-vehicle-lane (the HO V-lane 20), and the system 10 may select the HO V-lane 20 as the travel-lane 14 when a number of occupants 36 is sufficient (typically 2 or more occupants) to legally travel in the HOV-lane 20. Further explanations of various embodiments of the regulated-lane-detector 26 are presented later in this description. It is noted that it is not a requirement that the regulated-lane-detector 26 include all of the devices shown in FIG. 2. It is contemplated that the regulated-lane 18 may be detected by, for example, the image-capture device 34 alone. For example, the controller 22 may be configured to perform optical character recognition to determine information conveyed by signs or roadway markings. It is also contemplated that the regulations for a regulated lane may vary over time, either according to the time of day, day of the week, or long term regulation changes in accordance with revised government issued laws.

The system 10 may include an occupant-detection device 56 in communication with the controller 22 and operable to determine or indicate the number of occupants 36 in the vehicle 12. The number of occupants 36 may be detected by some device such as a camera 38, a seat sensor 40, or other means that does not require an occupant to manually enter a number. The seat sensor 40 may, for example, determine a weight of whatever is occupying a seat, or detect the influence on an electric field emitted by the seat sensor to determine if a seat is occupied. It is contemplated that the occupant may be made aware of the number of occupants 36 that have been detected so that a manual correction could be made the value stored in the controller 22 corresponding to number of occupants 36 to avoid violating regulations of the regulated-lane 18.

In one embodiment, the regulated-lane-detector includes an image-capture device 34 operable to detect a roadway-sign 42 indicative of the regulated-lane 18, for example the HOV-lane 20. The image-capture device 34 may be a visible light camera or an infrared camera which may include a light source to illuminate the roadway-sign 42. As used herein, the roadway-sign 42 may include, but are not limited to, markings on the surface of the regulated lane such as distinct symbols, lane-division markers, sign-posts, or other types of signage located near the edge of the roadway 16 or on overhead structures. The image-capture device 34 may be further configured to distinguish roadway signs from advertising signs by detecting if the sign is a retro-reflective type surface that is typically present in roadway signs. Alternatively, the image-capture device 34 may detect an image using known technologies such as radar, lidar, and the like.

It is recognized that known automated vehicle systems commonly use cameras to determine the position of the vehicle 12 relative to lane markers or stripes on the roadway 16. However, the system 10 described herein makes further use of that existing equipment to detect or determine information regarding the kind of lane or lanes are available for travel, so the system 10 can determine whether or not the vehicle-status 24 indicates that the vehicle does or does not comply with those regulations, and should or should not travel in the regulated-lane 18.

In another embodiment, the regulated-lane-detector 26 includes a wireless receiver 30 operable to receive a signal 44 indicative of the regulated-lane 18, for example the HOV-lane 20. The signal 44 may be transmitted by a low-power transmitter 46 proximate to the roadway 16, and the signal 44 may include information about what regulations are currently in effect with regard to the regulated-lane 18. Using the low-power transmitter 46 to communication regulations to the system 10 may be advantageous if the regulations for the regulated-lane 18 dynamically vary with time or traffic conditions. For example, if there is an accident in the right lane of FIG. 1, the regulations that limit access to the regulated-lane 18 may be temporarily suspended to allow traffic to more quickly get past the site of the accident.

The wireless receiver 30 may be part of a wireless transceiver capable of sending a signal to the low-power transmitter 46 (which would also be a transceiver) so that there is bi-directional communication between the vehicle 12 and the low-power transmitter 46. Bi-directional communication would provide for communication handshaking/verification of messages being sent/received, and thereby improve cyber security.

In another embodiment, the regulated-lane-detector includes a navigation device 32 operable to determine a location 48 of the regulated-lane 18, for example the HOV-lane 20. If the navigation device 32 by itself does not indicate the location 48 with enough precision for lane-keeping by the system 10, the navigation device 32 may at least indicate that, for example, the left lane is regulated-lane 18, and the system 10 may use other means such as a camera for lane-keeping.

In another embodiment, the regulated-lane-detector includes an internet-transceiver 28 operable to determine a lane-status 50 of the regulated-lane 18, for example the HOV-lane 20. Information from the internet-transceiver 28 may be combined with information from other devices in the regulated-lane-detector 26 to determine which of the travel-lane 14 the vehicle can legally travel.

The regulated-lane-detector 26 may also be operable to or configured to determine when the regulated-lane 18 is a public-transportation-only-lane (not shown but is understood to be in place of the HOV-lane 20). In this case, assuming that the vehicle 12 is not a public-transportation type vehicle, the system 10 avoids the public-transportation-only-lane as the travel-lane to when the vehicle-status is not classified as a public-transportation-vehicle. Alternatively, if the vehicle 12 is classified as a public-transportation vehicle, and this classification is stored in the controller 22, then the system 10 would select the public-transportation-only-lane to travel upon.

Information gathered by any of the devices in the regulated-lane-detector 26 may also be used by the controller to determine when the regulated-lane is a toll-lane (not shown but is understood to be in place of the HOV-lane 20). Accordingly, the system 10 may include a wireless transmitter 52 operable to transmit a toll-account-number 54 when the vehicle 12 travels in the toll-lane.

Accordingly, a system 10 for controlling the operation of an automated vehicle (the vehicle 12), and a controller 22 for the system 10 is provided. The system 10 and the controller 22 advance the automated vehicle arts by enabling the system 10 or the controller 22 to determine if or when the vehicle 12 legally entitled to operate in a regulated-lane 18, or if the regulated-lane 18 should be avoided because the vehicle 12 is not legally entitled.

While this invention has been described in terms of the preferred embodiments thereof, it is not intended to be so limited, but rather only to the extent set forth in the claims that follow.

We claim:

1. A system for automated operation of a vehicle, said system comprising:
a controller operable to determine a vehicle-status that indicates if the vehicle complies with regulations to legally travel in a regulated-lane of a roadway; and
a regulated-lane-detector in communication with the controller and operable to determine when a regulated-lane is present on a roadway, wherein the system selects a travel-lane for the vehicle to travel upon based on the vehicle-status.

2. The system in accordance with claim 1, wherein the controller is operable to steer a vehicle during automated operation of the vehicle.

3. The system in accordance with claim 1, wherein the regulated-lane-detector is operable to determine when the regulated-lane is a high-occupancy-vehicle-lane (HOV-lane), and the system selects the HOV-lane as the travel-lane when a number of occupants is sufficient to legally travel in the HOV-lane.

4. The system in accordance with claim 3, wherein the system includes an occupant-detection device in communication with the controller and operable to determine the number of occupants in the vehicle.

5. The system in accordance with claim 3, wherein the regulated-lane-detector includes an image-capture device operable to detect a roadway-sign indicative of the HOV-lane.

6. The system in accordance with claim 3, wherein the regulated-lane-detector includes a wireless receiver operable to receive a signal indicative of the HOV-lane.

7. The system in accordance with claim 3, wherein the regulated-lane-detector includes a navigation device operable to determine a location of the HOV-lane.

8. The system in accordance with claim 3, wherein the regulated-lane-detector includes an internet transceiver operable to determine a lane-status of the HO V-lane.

9. The system in accordance with claim 1, wherein the regulated-lane-detector is operable to determine when the regulated-lane is a public-transportation-only-lane, and
the system avoids the public-transportation-only-lane as the travel-lane to when the vehicle-status is not classified as a public-transportation-vehicle.

10. The system in accordance with claim 1, wherein the regulated-lane-detector is operable to determine when the regulated-lane is a toll-lane, and
the system includes a wireless transmitter operable to transmit a toll-account-number when the vehicle travels in the toll-lane.
